(19) United States
(12) Patent Application Publication
(10) Pub. No.: US 2010/0326676 A1
(43) Pub. Date: Dec. 30, 2010

(54) AUTOMATIC DRUM DRIP

(76) Inventors: JOSEPH PECORARO, LODI, NJ (US); RALPH FRAGOLA, CLOSTER, NJ (US)

Correspondence Address: Gearhart Law LLC, 41 River Road, Suite 1A, Summit, NJ, 07901, US

(21) Appl. No.: 12/826,824

(22) Filed: Jun. 30, 2010

Related U.S. Application Data
(60) Provisional application No. 61/269,903, filed on Jun. 30, 2009.

(51) Int. Cl. A62C 35/00

(52) U.S. Cl. 169/16

(57) ABSTRACT

The present invention involves a pipe assembly for discharging excess condensation from a closed circuit, pressurized air, fire sprinkler system. The disclosed invention has either one or two controlled valves and a water detection system that includes a sensor for detecting a predetermined amount of water in a water reservoir and a switch that triggers the discharge of excess condensation when a certain predetermined threshold is reached. The water detection system also contains an air pressure switch with sensor that deactivates the present invention in an event of sprinkler system activation. The water detection system determines the open and closed states of the controlled valves automatically or in response to inputs from a manual actuator switch or in response to a command from a remote command center.

### Claim of Priority

The present invention claims the priority of the U.S. Provisional Patent Application 61/269,903, filed on Jun. 30, 2009. The contents of the aforementioned applications are fully incorporated herein by reference.

### FIELD OF THE INVENTION

The invention relates to a device for automatic removal of accumulated condensation from a compressed air fire sprinkler system.

### BACKGROUND OF THE INVENTION

The present invention relates to a preventive plumbing device used for removing accumulated moisture from a compressed air fire sprinkler system. In dry fire protection sprinkler systems water is not present inside the pipes because of the danger of freezing which leads to the breakage and bursting of pipes. In dry systems the fire sprinkler system is pumped full of air and connected to a freely available water supply. The air pressure keeps water out of the pipes. But, if one of the sprinkler heads is opened, such as in the event of a fire, the air escapes through the opening. The air pressure quickly drops, triggering the sprinkler system and permitting the water to enter the pipes and to exit through the opened sprinkler head, hopefully dousing the flames.

However, one caveat of a compressed air system is that the water vapor component of the air condenses within the pipes as the surface temperature of the pipes drops. This condensation collects on internal surfaces of the fire sprinkler pipes. If the water condensate remains in the pipes it can cause rust, which could corrode the pipe and create a rupture. Consequently, fire sprinkler systems are designed so the pipes tilt toward an accumulation point. The fire sprinkler system is constructed with a slight downward grade to enable such a flow. The present invention embodies a pipe assembly that is attached to the accumulation point and is designed to collect this condensation runoff. However, a prolonged water presence within the fire sprinkler pipes is never desired, because it is corrosive or may break the pipes by freezing. A breach of this type will also activate the system and initiate a water flow through the breach into the internal cavities of a structure. This type water flow is highly undesirable since the resulting flooding causes property damage. The present invention provides sensors for detecting a predetermined amount of water in the water reservoir and for discharging this water without triggering the overall sprinkler system.

Although automatic and manual drainage devices are known in the art, they either lack proper detection and signaling sensors or are not fit to be used in fire sprinkler systems. The present invention offers many innovative benefits without the weaknesses apparent in the prior art.

### DESCRIPTION OF THE RELATED ART

U.S. Pat. No. 5,749,391 describes a condensate drainage system for pneumatic tanks. Large vehicles typically use compressed air for operating various vehicle functions such as its brakes. In conjunction with the use of compressed air there is provided a pneumatic system including a compressor and pneumatic storage tanks. Because of the properties of compressed air, it is necessary to drain condensates and contaminants from the pneumatic storage tanks in order to prevent the condensates and contaminants from migrating throughout the air system, and interfering with the operation of, the brakes. Accordingly, electrically controlled drain valves are connected to the pneumatic tanks for purging condensate and contaminants. A logic controller which receives inputs from sensors and determines an engine status controls the operation of the drain valves so as to optimally purge condensates and contaminants. The controller includes a CPU, programmable memory, and a timer. A push button control is also provided to override timing functions within the controller.

U.S. Pat. No. 6,102,066 describes a condensate drain for an automatic sprinkler system of the dry-pipe type wherein the drain includes a one piece water reservoir having a central chamber and tapering inlet and outlet chambers.

U.S. Pat. No. 6,443,173 teaches an automatic auxiliary condensate drain for an automatic dry-pipe type fire protection sprinkler system, wherein condensation which forms within the sprinkler system due to changes in temperature is drained from the condensate reservoir at the direction of a programmable controller. The programmable controller coordinates the opening and closing of inlet and outlet valves so that accumulated condensate is drained from the system, yet the pressurized gas located in the sprinkler system is not allowed to escape. Actuators operate the inlet and outlet valves in response to signals from the programmable controller.

U.S. Pat. No. 6,540,028 discloses a pressure operated normally closed control valve that operates to open at a predetermined pressure between the system minimum and maximum pressures to open the valve and allow the discharge of condensate from the system which has a source of pressure to provide a minimum and a maximum pressure. The system is subject to the formation of condensate. There is an inline filter at the inlet end of the valve and a discharge nozzle at the outlet end of the valve. The entrance to the discharge nozzle may also have a filter. The assembly can also be arranged so that the control valve is normally open and operates to open at a predetermined pressure at or below the system minimum pressure whereby condensate is removed, and to close the valve and prevent the discharge of condensate from the system when the pressure falls below the predetermined pressure.

Various implements are known in the art, but fail to address the problem solved by the invention described herein. One embodiment of this invention is illustrated in the accompanying drawings and will be described in more detail herein below.

### SUMMARY OF THE INVENTION

The present invention involves a pipe assembly for discharging excess condensation from a closed circuit, pressurized air, fire sprinkler system. The disclosed invention has two controlled valves and a water detection system that includes a sensor for detecting a predetermined amount of water in a water reservoir and a switch that triggers the discharge of excess condensation when a certain predetermined threshold is reached. The water detection system also contains an air pressure switch with sensor that deactivates the present invention in an event of sprinkler system activation. The water detection system determines the open and closed states of the controlled valves automatically or in response to inputs from a manual actuator switch or in response to a command from a remote command center. Before condensation is discharged the fire sprinkler system is sealed by closing the first controlled valve. The second controlled valve is then opened to discharge the water that has accumulated in the water reservoir. The second controlled valve then closes, and the first controlled valve reopens. The system is thus reset and is able to accumulate condensation within the water reservoir again. Alternatively, only a primary controlled valve is used and the discharge occurs very rapidly, propelled by the air pressure present in the fire sprinkler system. Under this alternative embodiment, the primary controlled valve must be disposed below the water reservoir.

It is the object of the present invention to provide a simple and reliable device for draining excess moisture from a fire sprinkler system.

It is another object of the present invention to prevent internal flooding of structures caused by broken fire sprinkler pipes.

Yet another object of the present invention is to provide an automatic mechanism for detecting and discharging condensation inside fire sprinkler systems. Still another object of the present invention is to provide a manual override and a remotely activated control of the water detection and discharge capabilities.

It is another object of the present invention to provide an override mechanism for the present invention in an event of an air pressure drop.

Yet another object of the present invention is to provide means for controlling the level of condensation within fire sprinkler system.

Still another object of the present invention is to provide a reliable fire sprinkler system that is resistant to corrosion and breakages.

### BRIEF DESCRIPTION OF THE DRAWINGS

FIG. 1 shows the preferred embodiment of the present invention having an automatic switch for discharging excess condensation and a manual override for the same function.

FIG. 2 shows an alternative embodiment of the present invention having a cutout cross section that demonstrates accumulation of water in the water reservoir and a manual actuator switch for discharging excess condensation.

FIG. 3 shows an alternative embodiment of the present invention having a cutout cross section that demonstrates the drainage of water in the pipe assembly. This figure also demonstrates an automatic discharge of excess condensation.

FIG. 4 shows an alternative embodiment of the pipe assembly of the present invention having an automatic switch for discharging excess moisture and a manual override for the same function. In this embodiment only one primary controlled valve is present.

FIG. 5 provides a schema of the electronic circuitry needed to enable the preferred embodiment of the present invention.

FIG. 6 provides a schema of the electronic circuitry of a control panel needed to enable the preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

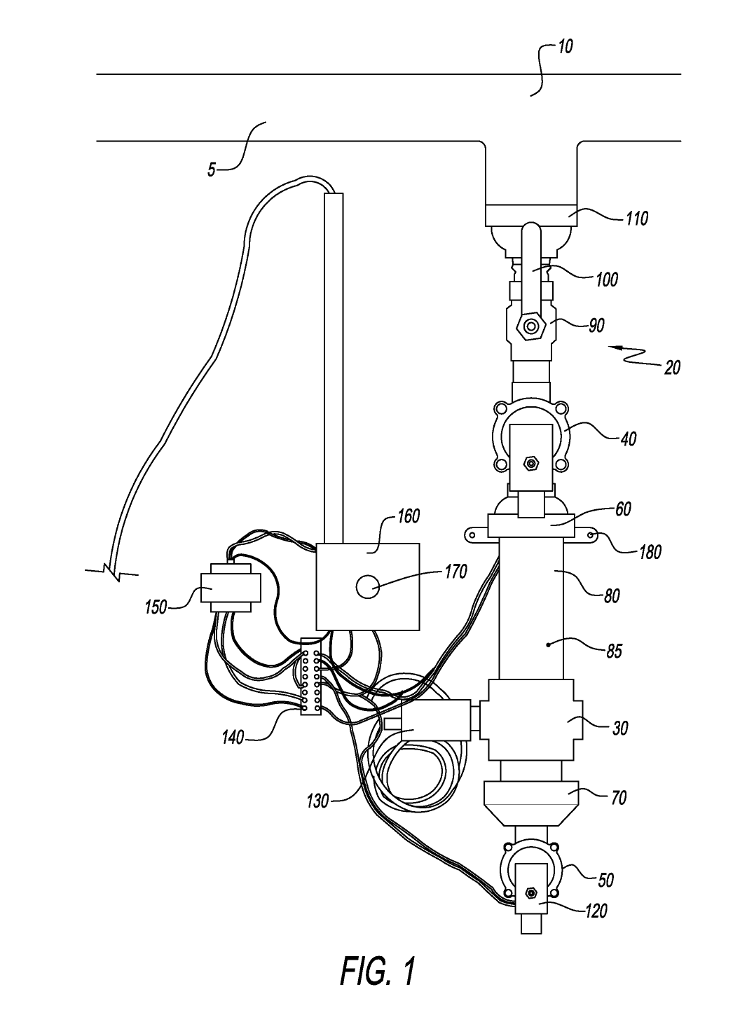

FIG. 1 shows a preferred embodiment of the present invention. Shown are a graded pipe 5, an accumulation point 10, a pipe assembly 20, a water detection device 30, a first controlled valve 40, a second controlled valve 50, a first connector 60, a second connector 70, a water reservoir 80, a sidewall 85, a shutoff valve 90, a shutoff valve handle 100, an intake section 110, a drain section 120, an automatic switch 130, a wiring panel 140, a power source 150, a manual actuating switch 160, a manual switch actuator 170, and a mounting bracket 180. It is contemplated that the shutoff valve 90 may be optional is some embodiments of the present invention.

A typical fire sprinkler system is composed of several sections. For the sake of clarity, the graded pipe 5 represents an entire system of pipes making up a fire sprinkler system. The grading must be between ¼″ and ½″ drop per 10 ft., to ensure unimpeded flow of condensation towards the accumulation point 10. The accumulation point 10 is the lowest point of the fire sprinkler system and is ideal location placement of the present invention. Larger sprinkler systems may have more than one accumulation point. The invention may also be mounted with a mounting bracket 180 to a wall or a vertical structural element for extra support. Said mounting bracket 180 may be unitary with one of the components of the present invention or as a separate mountable component, such as a post pipe bracket or a hanger pipe bracket.

Still referring to FIG. 1, the pipe assembly 20 is an assembly of all individual components of the present invention into a pipe like structure. The pipe assembly 20 is joined with the graded pipe 5 at the accumulation point 10. The methods of attaching the pipe assembly can include, but not limited to, welding, attaching with adhesives or threaded components that may further have Teflon tape insulation for a tighter connection. The actual method used depends on the type of the pipe being used for the pipe assembly 20. Any piping type can be used for the pipe assembly 20, including, but not limited to, iron, metal, copper or polyvinyl chloride (also known as PVC). The type of piping used is most likely dictated by housing, plumbing or fire safety regulations pertinent to the locale where the present invention is being used.

FIG. 1 further shows a shutoff valve 90 with a shutoff valve handle 100. The primary purpose of the shutoff valve 90 is to enable maintenance of the pipe assembly 20, or to serve as a backup valve that prevents air from escaping; if for some reason both the first controlled valve 40 and the second controlled valve 50 are open and cannot be closed. The shutoff valve 90 is not critical to enable or operate the present invention. As shown in FIG. 1, the shutoff valve 90 connects directly to the first controlled valve 40 either with solder, adhesive or threading, or any other type of airtight permanent connection. The shutoff valve 90 is pictured as a ball valve, but can also be a butterfly valve, or any other valve capable of providing airtight and water tight seal. The shutoff valve 90 is opened and closed manually by turning a shutoff handle 100 either clockwise or counter clockwise. Alternatively, this valve may also be a controlled valve (not shown) along with the first controlled valve 40 and the second controlled valve 50.

Liquid condensation flows down the graded pipe 5 into the pipe assembly 20 through the accumulation point 10. Once in the pipe assembly 20, the droplets will flow through the intake section 110, the shutoff valve 90, if such is present, through the first controlled valve 40, and into the water reservoir 80. The water reservoir 80 contains a water detection device 30 that contains a sensor (not shown). The water reservoir 80 is pictured in FIG. 1 in form of a cylindrical pipe, but may be in any other shape that would permit proper operation of the water detection device 30. The water sensor can be any type of a sensor, such as, but not limited to a sonar, optical, weight sensor or a solenoid. It is contemplated that in some embodiments of the present invention, the water detection device 30 that contains a sensor (not shown) is oriented to be parallel or in the same plane as the second controlled valve 50.

The water reservoir 80 accumulates condensation until a predetermined level is reached. The level can be configurable or permanently preset within the circuitry of the water detection device 30. Once the predetermined level is reached, the water detection device signals to the automatic switch 130 that a discharge of condensation is needed. If functioning properly, the automatic switch 130 then causes the first controlled valve 40 to close and the second controlled valve 50 to open, thus discharging the water into a container or the floor below. The water discharge is propelled with the basic downward gravitational pull of the earth that is further assisted with any air pressure captured when the first controlled valve 40 closed.

Alternatively, if desired, the water can be drained manually by engaging the manual activator switch 170, which is part of the manual switch 160. The manual switch 160 may contain some kind of indication means for determining the level of water within the water reservoir 80. Once water reservoir 80 is completely drained, the second controlled valve 50 is closed and the first controlled valve 40 is reopened and the condensation can once again accumulate in the water reservoir 80.

Referring back to FIG. 1, the power source 150 supplies electrical current to the pipe assembly 20 through a wire patch 140. The wire patch 140 is not needed to enable the present invention as all components can be wired to connect directly to the power source 150. The power source 150 can be in form of a battery pack, such as for remote regions where central electrical supply is not available. For ideal autonomy of the present invention, it is preferred that the main source of electrical supply for the structure will also supply power to operate the present invention. Another alternative would be to use electrical power for the water detection device 30, the manual switch 160, and the automatic switch 130; and to use mechanical or pneumatic power to control the first controlled valve 40 and the second controlled valve 50. The overall length of the preferred embodiment of the present invention is preferably between 14 and 24 inches.

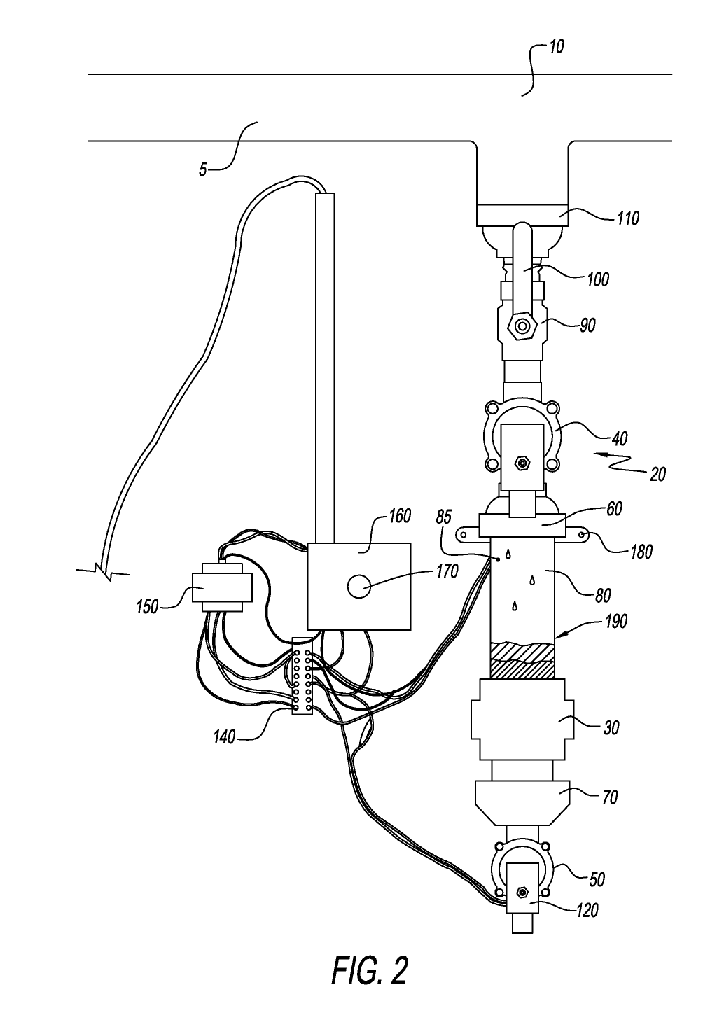

FIG. 2 displays the first alternative embodiment of the present invention. Shown are a graded pipe 5, an accumulation point 10, a pipe assembly 20, a water detection device 30, a first controlled valve 40, a second controlled valve 50, a first connector 60, a second connector 70, a water reservoir 80, a sidewall 85, a shutoff valve 90, a shutoff valve handle 100, an intake section 110, a drain section 120, a wiring panel 140, a power source 150, a manual switch 160, a manual actuator switch 170, and a mounting bracket 180. The cross sectional cutout of the sidewall 85 of the water reservoir 80 also shows liquid condensation 190 accumulating within the water reservoir 80. It is contemplated that the shutoff valve 90 may be optional is some embodiments of the present invention.

All of the preferred structural components of the present invention, such as the first connector 60, the second connector 70, an intake section 110 and a drain section 120 are tubular and hollow inside to permit the free flow of condensation through the pipe assembly 20. These components are not essential to enablement of the present invention. The essential parts of the present invention are at least the first controlled valve 40 or the second controlled valve 50, the water reservoir 80, the water detection device 30, and either the manual switch 130 or the automatic switch 160, along with some type of power source 150. The intake, accumulation and discharge of condensation can be handled exclusively by the first and second controlled valves 40 and 50, and by the water reservoir 80; and can be connected directly to each other without the presence of the first connector 60 or the second connector 70. The various components of the present invention may be manufactured out of the same or different materials.

Referring back to FIG. 2, if only the manual switch 160 is used to drain condensation, then some kind of an indicator showing the level of water is likely to also be present. One type of an indicator can be in form of a see through window (not shown) in the side wall 85 of the water reservoir 80. Such a see through window may additionally contain gradations (not shown) for a more precise determination of the volume of the present condensation. Alternatively, an indicator may be electrically powered, such as a color diode that lights up when a threshold is reached or a more sophisticated or even digital indicator capable of displaying the water level with greater precision and detail. Since the present invention will usually be mounted under the ceiling, it may be advisable to have a wireless remote control receiver (not shown) be coupled with the manual switch 160. Such a wireless remote control receiver would then react to signals from a wireless remote device issued to janitors or maintenance crews. This way the condensation can be drained in places with high ceilings without the need for elevation devices, such as ladders or lifts. Embodiment shown in FIG. 2 is not preferred because the ability to manually discharge excess condensation is less efficient then the automatic operation.

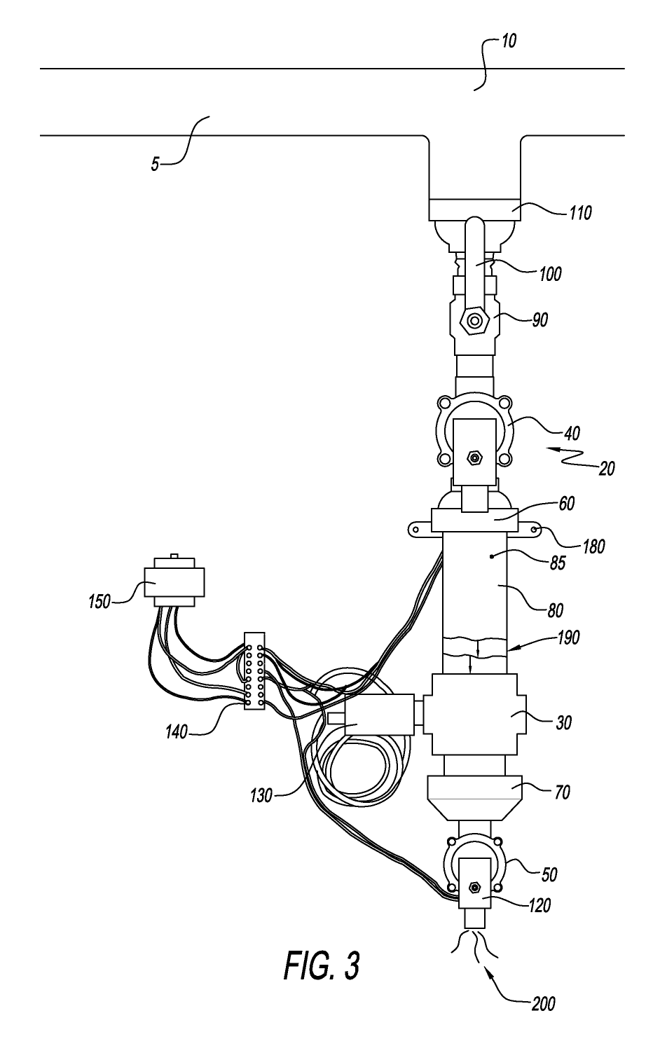

FIG. 3 shows another alternative embodiment of the present invention. Shown are the a graded pipe 5, an accumulation point 10, a pipe assembly 20, a water detection device 30, a first controlled valve 40, a second controlled valve 50, a first connector 60, a second connector 70, a water reservoir 80, a sidewall 85, a shutoff valve 90, a shutoff valve handle 100, an intake section 110, a drain section 120, an automatic switch 130, a wiring panel 140, a power source 150, and a mounting bracket 180. FIG. 2 contains a cutout in the sidewall 85 of the reservoir 80 that shows the system at the point when condensation is being drained. The cross sectional cutout in the sidewall 85, of the water reservoir 80, demonstrates how the level of condensation 190 falls as the liquid condensation outflow 200 exits the pipe assembly 20 through the drain section 120. This alternative embodiment is not preferred since there are no manual override means available for testing or draining the pipe assembly 20.

It is contemplated that in some embodiments of the present invention, it may be desired to control the present invention remotely through a remote control center (not shown). Such a remote control center may include or be limited to a central processing unit, also known as a computer that is responsible for keeping track of condensation levels and for authorizing water discharges as needed. In such a case, the most likely scenario would be for either the sensor within the water detection system 30 or the automatic switch 130, to send status signals, digitally or via radio or electromagnetic waves to a remote control center (not shown). A remote control center receiving these status signals would then be able to determine whether a water level threshold has been reached, and issue a return signal to the pipe assembly 20 directing it to discharge or to retain excess condensation.

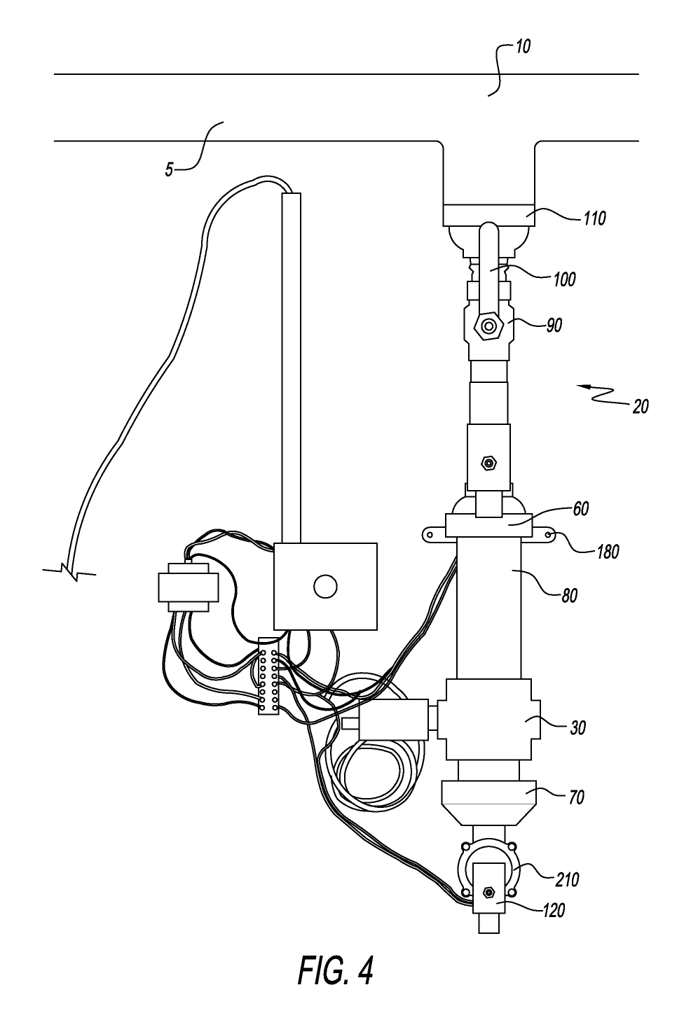

FIG. 4 shows yet another alternative embodiment of the invention. Shown are a graded pipe 5, an accumulation point 10, a pipe assembly 20, a water detection device 30, a first connector 60, a second connector 70, a water reservoir 80, a sidewall 85, a shutoff valve 90, a shutoff valve handle 100, an intake section 110, a drain section 120, an automatic switch 130, a wiring panel 140, a power source 150, a manual switch 160, a manual actuator switch 170, a mounting bracket 180, and a primary controlled valve 210.

In FIG. 4 the primary controlled valve 210 handles the retention and discharge of condensation. This embodiment of the present invention operates analogously to the steps described in FIG. 1. The difference is that the primary controlled valve 210 is opened and closed very rapidly so that the air pressure does not escape and the sprinkler system is thus not triggered. Notice in FIG. 4 that while the primary controlled valve 210 is open, only the shutoff valve 90 is capable of sealing the fire sprinkler system, in the event of a malfunction involving the primary controlled valve 210. Just enough air is permitted to escape outside, through the primary controlled valve 210, to enable the water reservoir 80 to empty completely. The air pressure present in the fire sprinkling system serves as the primary propellant force needed to enable the rapid discharge of the excess condensation. This embodiment is therefore cheaper to manufacture and less costly to maintain. Alternatively, a specialized piston (not shown) can be also be used to propel the water out of the invention.

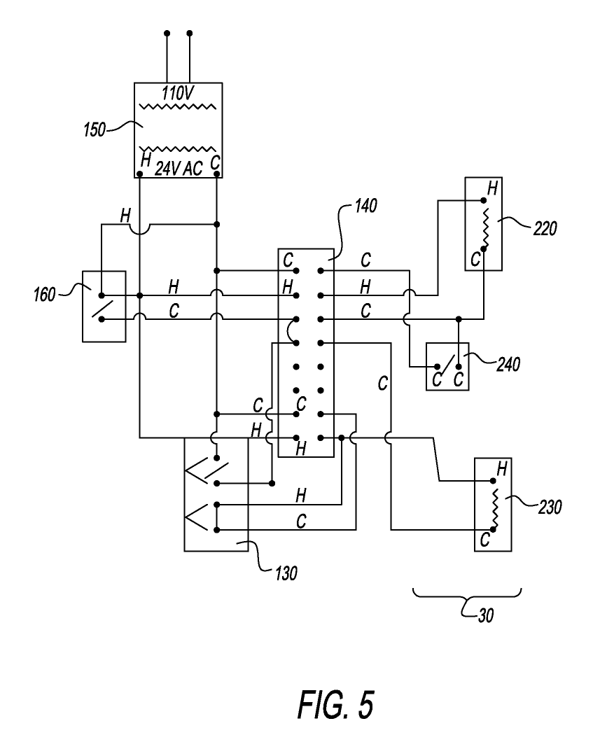

FIG. 5 is a schematic representation of the electrical connectors that enable the present invention. Shown are a water detection device 30, an automatic switch 130, a wiring panel 140, a power source 150, a manual switch 160, a first valve solenoid 220, a second valve solenoid 230, and a pressure switch 240. In one embodiment of the present invention, the power source 150 connects to the central electrical grid of a building through a transformer mechanism which converts standard residential level voltages in the power grid into the voltage required by the present invention. One skilled in the art will appreciate that the transformer component of the power source 150 need not be included in every embodiment. All other electrical components of the present invention connect to the power source 150 through the wiring panel 140.

The first valve solenoid 220, the second valve solenoid 230, and the pressure switch 240 represent a list of preferred electronic components forming the water detection device 30. Alternatively, each component may function separately and be located in a different location within the fire sprinkler system. The first valve solenoid 220 controls the operation of the first controlled valve 40, or in an embodiment having only one controlled valve, it controls the primary controlled valve 210. The second valve solenoid 230 controls the operation of the second valve 50.

Also controlling the operation of the first valve 40, or the primary controlled valve 210, is the pressure switch 240. The pressure switch 240 activates a closure of the first controlled valve 40, or the primary controlled valve 210, when it detects a drop in the air pressure within the fire sprinkler system to a level below the level that is required to prevent an influx of water; preferably, 150 pounds per square inch (psi). A drop in the air pressure indicates that the sprinkler system has been triggered. The pressure switch 240 thus serves to prevent waste of a significant amount of water that would be drained through the present invention, since the water permeating the triggered fire sprinkler system would also trigger the operation of the present invention. Without the pressure switch 240, the sprinkler system may even be rendered nonoperational if triggered. This is a possibility because the present invention resides at lowest point of the sprinkler system. Thus a rapid enough rate of opening and closing of the first and second controlled valves 40 and 50 may act to drain the water permeating the present invention before enough of it reaches the sprinkler heads (not shown). For this reason, the manual switch 160 should not override the action of the pressure switch 240. Notice also that the first valve solenoid 220 and the pressure switch 240 are interconnected, since both activate the first controlled valve 40 or the primary controlled valve 210.

The pressure switch 240 or at least the pressure sensor section (not shown separately) of the pressure switch 240 should be preferably disposed 6″ (six inches) above the first valve solenoid 220, to accurately gauge the air pressure. Alternatively, the pressure sensor may reside anywhere within the fire sprinkler system, such as on each sprinkler head, or centrally in the main valve room, or in another central location.

Still referring to FIG. 5, the automatic switch 130 contains circuitry for the manual switch 160 and the power supply 150. This illustrates that the manual switch 160 in general, overrides the present directive of the water detection device 30, unless the pressure switch 240 has closed the first controlled valve 40, due to a drop in air pressure within the fire sprinkler system. However, both the manual switch 160 and the automatic switch 130 need electrical power from the power source 150 to activate the present invention. In an event of an electrical outage, the power source 150 may be secondarily connected to a separate auxiliary power supply (not shown). Alternatively, the second controlled valve 50 or the primary controlled valve 210 will remain in their default closed state until the power is restored. The shutoff valve 90 also functions as a manual backup to the present invention, to guard against a malfunction or a power failure.

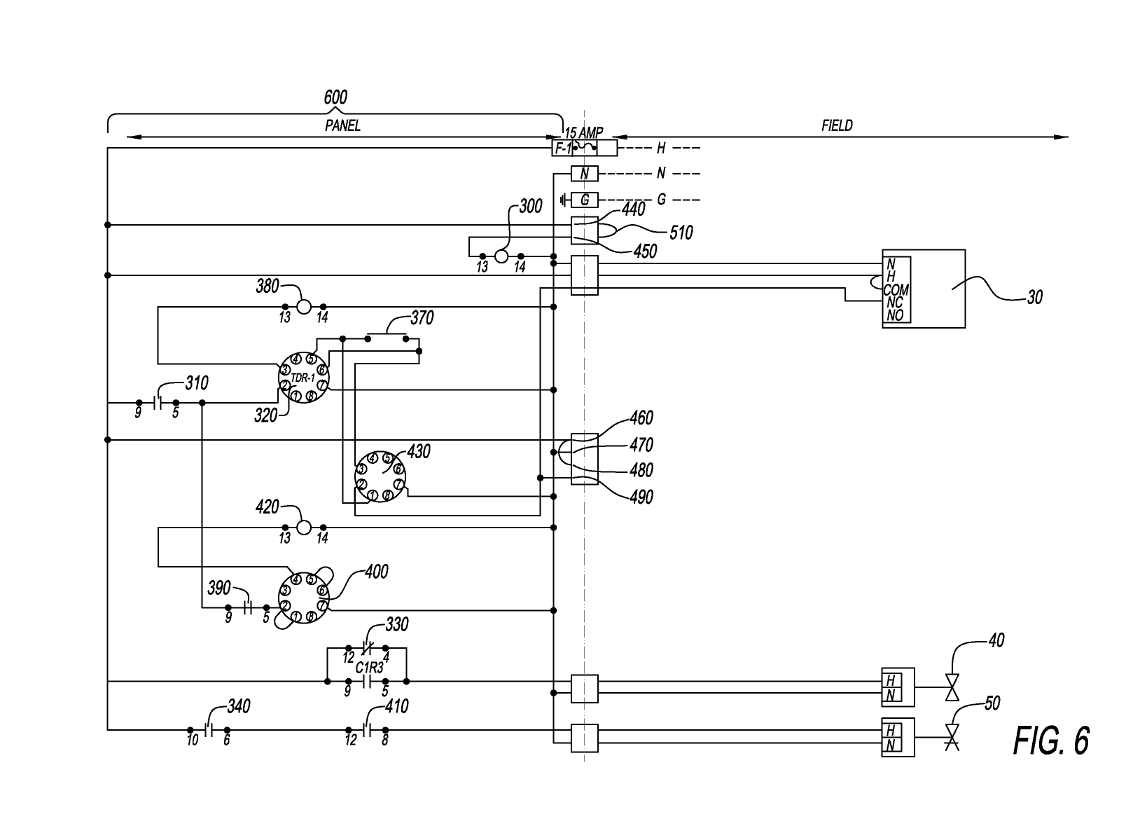

FIG. 6 is a schematic representation of electronic circuitry and relays of a control panel (600) that enables an embodiment of the present invention.

When electrical power from power source 150 is first applied to activate the present invention, a relay, R-1 (300), will energize. A contact, C1R1 (310), will close powering a time delay relay, TDR-1 (320). A contact, C2R1 (330), will open and a contact, C3R1 (340), will close allowing normal operation of first controlled valve (40) and a second controlled valve (50) via a first valve solenoid (not shown) and a second valve solenoid (not shown) respectively.

When key switch, KEYSW-1 (370), is activated, a signal is sent to a time delay relay, TDR-1 (320). The time delay relay, TDR-1 (320), will have a 5 second pulse and energize a relay, R-2 (380). A contact, C1R2 (390), shall power up a time delay relay, TDR-2 (400). A contact, C2R2 (410), shall open second controlled valve (50). A time delay relay, TDR-2 (400), shall delay energizing a relay, R-3 (420), for ½ second. This shall allow both first controlled valve (40) and a second controlled valve (50) to be open and blow any water out of the system. After ½ second, a relay R-3 (420), shall energize closing first controlled valve (40). Second controlled valve (50) shall remain open for the entire 5 seconds period allowing any additional water to drip out. After 5 seconds, relay R-2 (380) shall de-energize. This will kill power to time delay relay, TDR-2 (400), and relay R-3 (420). First controlled valve (40) shall reopen and second controlled valve (50) shall close. This shall happen regardless of the position of KEYSW-1 (370). Only after KEYSW-1 (370) has been deactivated, will the system reset and allow another pulse.

If water detector (30) senses water in the pipe, its contact shall close and energize time delay relay TDR-3 (430). Time delay relay, TDR-3 (430) will energize its contacts for a maximum period of 1 minute. This shall initiate a trigger pulse on time delay relay, TDR-3 (430), which shall initiate a valve cycle. If the water detector (30) senses no more water, time delay relay TDR-3 (430) shall de-energize. Should there continue to be water in the pipe (or the probe becomes defective), time delay relay TDR-3 (430) shall open its contacts after a 1 minute period. It will then delay for 60 minutes before initiating another 1 minute pulse to time delay relay, TDR-1 (320). In this manner, the pipe assembly (20) shall only be bled once an hour in the event of a defective water detector (30). Pressing the push button during this timeout period shall allow the operator to start a valve cycle via manual switch (not shown) or automatic switch (not shown).

An optional time clock may be powered from terminals 460 and 470. Dry contacts from this time clock, or from a BMS system contact (terminals 480, 490) will also initiate a trigger of time delay relay, TDR-2 (400). The operation of the time clock (460,470), or BMS system contact, (480,490) contact is the same as the water detector (30).

A jumper (510) is placed across terminals 440 and 450 for fire alarm purposes. When the jumper (510) is removed (or the normally closed fire contact goes open), relay R-1 (300) is de-energized. This disables the control panel (600) by removing power to time delay relay TDR-1 (320) and time delay relay TDR-2 (400) via contact C1R1 (310). Contact C2R1 (330) shall close and energize first controlled valve (40) thereby closing it. Contact C3R1 (340) opens removing power from second controlled valve (50) also closing it. By having both first controlled valve (40) and second controlled valve (50) closed, a double safety against leakage during the fire situation is initiated.

Once the fire alarm is cleared, normal control panel operation shall be resumed.

It is also contemplated that in some embodiments of the present invention, a heat tracing wire may be connected to a separate terminal in the control panel.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. A fire sprinkler system comprising;
a graded pipe system having a condensation accumulation point;
a pipe assembly disposed at said accumulation point, having a first controlled valve and a second controlled valve, a water reservoir disposed between said controlled valves;
a water detection device having a water sensor, wherein the water sensor is capable of detecting a presence of a predetermined amount of water in the water reservoir,
and wherein the first controlled valve closes, and the second controlled valve opens when the predetermined amount of water is present in the system; and the second controlled valve closes and the first controlled valve opens after the water reservoir is empty; and
wherein the water detection device automatically controls said controlled valves.

2. The fire sprinkler system of claim 1, wherein said controlled valves are controlled manually.

3. The fire sprinkler system of claim 1, further comprising an intake section and a drain section.

4. The fire sprinkler system of claim 1, further comprising a shutoff valve, wherein said shutoff valve is capable of preventing the transfer of water or air from said accumulation point to said pipe assembly.

5. The fire sprinkler system of claim 1, wherein said water detection device is powered by a battery pack

6. The fire sprinkler system of claim 1, wherein said water sensor communicates the presence of water to a remote control center, said remote control center controlling said controlled valves.

7. The fire sprinkler system of claim 1, wherein said water detection device further comprises capability to detect air pressure within said graded pipe system.

8. A fire sprinkler system comprising;
a graded pipe system having a condensation accumulation point;
a pipe assembly disposed at said accumulation point, having a first controlled valve and a second controlled valve, a water reservoir disposed between said controlled valves;
a water detection device having a water sensor, wherein the water sensor is capable of detecting a presence of a predetermined amount of water in the water reservoir; and
a manual switch, said manual switch controlling said controlled valves,
and wherein the first controlled valve closes, and the second controlled valve opens when the predetermined amount of water is present in the system; and the second controlled valve closes and the first controlled valve opens after the water reservoir is empty.

9. The fire sprinkler system of claim 8, further comprising an intake section and a drain section.

10. The fire sprinkler system of claim 8, further comprising a shutoff valve, wherein said shutoff valve is capable of preventing the transfer of water or air from said accumulation point to said pipe assembly.

11. The fire sprinkler system of claim 8, wherein the water detection device automatically controls said controlled valves.

12. The fire sprinkler system of claim 8, wherein said manual switch contains a remote control receiver.

13. The fire sprinkler system of claim 12, wherein said remote control receiver is wireless.

14. The fire sprinkler system of claim 8, wherein said water detection device further comprises capability to detect air pressure within said graded pipe system.

15. A fire sprinkler system comprising;
a graded pipe system having a condensation accumulation point;
a pipe assembly disposed at said accumulation point, having a first controlled valve and a second controlled valve, a water reservoir disposed between said controlled valves;
a water detection device having a water sensor, wherein the water sensor is capable of detecting a presence of a predetermined amount of water in the water reservoir,
and wherein the first controlled valve closes, and the second controlled valve opens when the predetermined amount of water is present in the system; and the second controlled valve closes and the first controlled valve opens after the water reservoir is empty; and
wherein the water detection device automatically controls said controlled valves; and
a manual switch, said manual switch controlling said controlled valves, and
wherein said manual switch overrides said water detection device.

16. The fire sprinkler system of claim 14, further comprising an intake section and a drain section.

17. The fire sprinkler system of claim 14, further comprising a shutoff valve, wherein said shutoff valve is capable of preventing the transfer of water or air from said accumulation point to said pipe assembly.

18. The fire sprinkler system of claim 14, wherein said water sensor communicates the presence of water to a remote control center, said remote control center automatically controlling said controlled valves.

19. The fire sprinkler system of claim 14, wherein said manual actuator switch contains a remote control receiver.

20. The fire sprinkler system of claim 14, wherein said water detection device further comprises capability to detect air pressure within said graded pipe system.

21. A fire sprinkler system comprising,
a graded pipe system having a condensation accumulation point;
a pipe assembly disposed at said accumulation point, having a primary controlled valve;
a water reservoir disposed above said primary controlled valve;
a water detection device having a water sensor, wherein the water sensor is capable of detecting a presence of a predetermined amount of water in the water reservoir,
and wherein the primary controlled valve opens and closes rapidly to expel said predetermined amount of water; and
wherein the water detection device automatically controls said controlled valve; and
a manual switch, said manual switch controlling said primary controlled valve,
and wherein said manual switch overrides said water detection device.

22. The fire sprinkler system of claim 21, further comprising an intake section and a drain section.

23. The fire sprinkler system of claim 21, further comprising a shutoff valve, wherein said shutoff valve is capable of preventing the transfer of water or air from said accumulation point to said pipe assembly.

24. The fire sprinkler system of claim 21, wherein said water sensor communicates the presence of water to a remote control center, said remote control center automatically controlling said primary controlled valve.

25. The fire sprinkler system of claim 21, wherein said manual actuator switch contains a remote control receiver.

26. The fire sprinkler system of claim 21, wherein said water detection device further comprises capability to detect air pressure within said graded pipe system.
